(19) United States
(12) Patent Application Publication
(10) Pub. No.: US 2012/0160588 A1
(43) Pub. Date: Jun. 28, 2012

(54) EXHAUST DEVICE OF A VEHICLE AND A UTILITY VEHICLE PROVIDED WITH THE SAME

(76) Inventor: Jun TAKAGI, Akashi-shi (JP)

(21) Appl. No.: 12/979,668

(22) Filed: Dec. 28, 2010

(51) Int. Cl. B60K 5/00; F01N 13/08; B60K 13/04

(52) U.S. Cl. 180/291; 181/228

(57) ABSTRACT

To provide an exhaust device capable of suppressing exhaust interference generated between a front cylinder exhaust pipe and a rear cylinder exhaust pipe, and further substantially equalizing an exhaust performance of front and rear cylinders. An exhaust device of a vehicle provided with a V-engine 5 having a front cylinder 52 and a rear cylinder 53 has a muffler 93 arranged in a rear part of the vehicle, a front cylinder exhaust pipe 91 connected to a front surface of the front cylinder 52, a rear cylinder exhaust pipe 92 connected to a rear surface of the rear cylinder 53, a collecting pipe 94 collecting the front cylinder exhaust pipe 91 and the rear cylinder exhaust pipe 92, and a downstream exhaust pipe 95 reaching from the collecting pipe 94 to the muffler 93. Total length of the front cylinder exhaust pipe 91 and total length of the rear cylinder exhaust pipe 92 are substantially the same.

### BACKGROUND OF THE INVENTION

1. Field of the Invention

The present invention relates to an exhaust device of a vehicle provided with an engine, and a running vehicle provided with the same, particularly to a utility vehicle mainly suitable for running on irregular terrain.

2. Description of the Related Art

Conventionally, in a utility vehicle provided with a V-engine having a front cylinder and a rear cylinder, as shown in FIG. 4 of U.S. Pat. No. 6,719,084, a front cylinder exhaust pipe connected to a front surface of the front cylinder, the front cylinder exhaust pipe reaching to a muffler has longer total length than a rear cylinder exhaust pipe connected to a rear surface of the rear cylinder, the rear cylinder exhaust pipe reaching to the muffler.

### SUMMARY OF THE INVENTION

When the front cylinder exhaust pipe is longer than the rear cylinder exhaust pipe, exhaust interference is generated between the front cylinder exhaust pipe and the rear cylinder exhaust pipe, or a difference in an exhaust performance is generated between the front and rear cylinders, so that an output of the engine tends to be lowered. Therefore, an object of the present invention is to provide an exhaust device capable of suppressing the exhaust interference generated between the front cylinder exhaust pipe and the rear cylinder exhaust pipe, and further substantially equalizing the exhaust performance of the front and rear cylinders.

A first aspect of the present invention is an exhaust device of a vehicle provided with a V-engine having a front cylinder and a rear cylinder, including a muffler arranged in a rear part of the vehicle, a front cylinder exhaust pipe connected to a front surface of the front cylinder, a rear cylinder exhaust pipe connected to a rear surface of the rear cylinder, a collecting pipe collecting the front cylinder exhaust pipe and the rear cylinder exhaust pipe, and a downstream exhaust pipe reaching from the collecting pipe to the muffler, wherein total length of the front cylinder exhaust pipe and total length of the rear cylinder exhaust pipe are substantially the same.

With the above configuration, the total length of the front cylinder exhaust pipe and the total length of the rear cylinder exhaust pipe are substantially the same. Thus, the exhaust interference generated between the front cylinder exhaust pipe and the rear cylinder exhaust pipe can be suppressed, and further the exhaust performance of the front and rear cylinders can be substantially equalized. As a result, the output of the engine can be improved.

The first aspect of the present invention is preferably provided with the following configurations.

(1) The collecting pipe is arranged on the side in the lateral direction of a rear part of the engine, the front cylinder exhaust pipe has a front exhaust pipe curved portion changing the direction from forward to rearward, the front exhaust pipe curved portion is positioned in the vicinity of the front side of the engine, the rear cylinder exhaust pipe has, in order from the exhaust upstream side, a first rear exhaust pipe curved portion changing the direction from rearward to forward, and a second rear exhaust pipe curved portion changing the direction from forward to rearward, the first rear exhaust pipe curved portion is positioned in the vicinity of the rear side of the engine, and the second rear exhaust pipe curved portion is positioned in the vicinity of the side in the lateral direction of the rear part of the engine.
(2) In the above configuration (1), the collecting pipe is arranged on the opposite side in the lateral direction of a fuel tank or a transmission of the vehicle relative to the engine.
(3) In the above configuration (1), the front cylinder exhaust pipe has a front exhaust pipe straight portion formed into a straight line in a connection part to the collecting pipe, and the rear cylinder exhaust pipe has a rear exhaust pipe straight portion formed into a straight line in a connection part to the collecting pipe.
(4) In the above configuration (2), the front exhaust pipe straight portion and the rear exhaust pipe straight portion are integrally supported by a shared support member.
(5) In the above configuration (1), a cutout portion of an oil pan is formed in a side part in the lateral direction of the oil pan of the engine, and a part of the second rear exhaust pipe curved portion is positioned in the vicinity of the cutout portion.
(6) The vehicle has a front seat and a rear seat in order from the front side, the engine is arranged on the lower side of a substantially center part in the lateral direction of the front seat, the muffler is arranged in the vicinity of the lower side of a loading platform in a rear part of the rear seat and in a substantially center part in the lateral direction, and the downstream exhaust pipe reaches to the muffler through the lower side of the substantially center part in the lateral direction of the rear seat.

The configuration (1) is a specific configuration that the total length of the front cylinder exhaust pipe and the total length of the rear cylinder exhaust pipe are substantially the same. With the above configuration (1), the total length of the front cylinder exhaust pipe and the total length of the rear cylinder exhaust pipe can easily be made substantially the same. With the above configuration (1), the front cylinder exhaust pipe and the rear cylinder exhaust pipe can be arranged around the engine. Thus, a thermal influence from the front cylinder exhaust pipe and the rear cylinder exhaust pipe to the outer side in the lateral direction can be reduced.

With the configuration (2), the collecting pipe is arranged on the opposite side in the lateral direction of the fuel tank or the transmission of the vehicle relative to the engine. Thus, the front cylinder exhaust pipe, the rear cylinder exhaust pipe, and the collecting pipe having a relatively high temperature among the exhaust pipes are spaced from the fuel tank or the transmission by a fixed distance via the engine. Therefore, the thermal influence on the fuel tank or the transmission by the front cylinder exhaust pipe, the rear cylinder exhaust pipe, and the collecting pipe can be reduced.

With the configuration (3), the front cylinder exhaust pipe and the rear cylinder exhaust pipe respectively have the front exhaust pipe straight portion formed into a straight line and the rear exhaust pipe straight portion formed into a straight line in the connection parts to the collecting pipe. Thus, movement of exhaust from the front cylinder exhaust pipe to the collecting pipe, and movement of exhaust from the rear cylinder exhaust pipe to the collecting pipe can be smoothly performed.

With the above configuration (4), the front exhaust pipe straight portion and the rear exhaust pipe straight portion are integrally supported by the shared support member. Thus, the support member can be simplified, so that the front exhaust pipe straight portion and the rear exhaust pipe straight portion can be supported in a rational manner. By improving integrity of the front cylinder exhaust pipe and the rear cylinder exhaust pipe, vibration generated between the front cylinder exhaust pipe and the rear cylinder exhaust pipe can be eased.

With the above configuration (5), a part of the second rear exhaust pipe curved portion is positioned in the vicinity of the cutout portion of the oil pan. Thus, the rear cylinder exhaust pipe can be brought close to the side in the lateral direction of the engine, so that the thermal influence from the rear cylinder exhaust pipe to the outer side in the lateral direction can be reduced.

With the above configuration (6), the engine and the muffler are arranged in the substantially center part in the lateral direction, and the downstream exhaust pipe passes through the lower side of the substantially center part in the lateral direction of the rear seat. Thus, total length of the downstream exhaust pipe can be shortened. As a result, weight of the downstream exhaust pipe can be reduced, and the output of the engine at the time of high speed can be improved. Since the downstream exhaust pipe is arranged in the substantially center part in the lateral direction, the thermal influence from the downstream exhaust pipe to the outer side in the lateral direction can be reduced.

A second aspect of the present invention is an exhaust device of a vehicle provided with an engine having one or more cylinder, including a muffler, and an exhaust pipe connected to the cylinder, the exhaust pipe reaching to the muffler, wherein the vehicle has a front seat and a rear seat in order from the front side, the engine is arranged on the lower side of a substantially center part in the lateral direction of the front seat, the muffler is arranged in the vicinity of the lower side of a loading platform in a rear part of the rear seat and in a substantially center part in the lateral direction, and the exhaust pipe reaches to the muffler through the lower side of the substantially center part in the lateral direction of the rear seat.

With the above configuration, the engine and the muffler are arranged in the substantially center part in the lateral direction, and the exhaust pipe passes through the lower side of the substantially center part in the lateral direction of the rear seat. Thus, total length of the exhaust pipe can be shortened. As a result, weight of the exhaust pipe can be reduced, and the output of the engine at the time of high speed can be improved. Since the exhaust pipe is arranged in the substantially center part in the lateral direction, the thermal influence from the exhaust pipe to the outer side in the lateral direction can be reduced.

A third aspect of the present invention is a utility vehicle provided with the exhaust device of the first aspect or the second aspect of the present invention.

With the above configuration, the utility vehicle having an effect of the first aspect of the present invention or an effect of the second aspect of the present invention can be provided.

In sum, according to the present invention, the exhaust interference generated between the front cylinder exhaust pipe and the rear cylinder exhaust pipe can be suppressed, and further the exhaust performance of the front and rear cylinders can be substantially equalized.

### BRIEF DESCRIPTION OF THE DRAWINGS

FIG. 1 is a left side view of a utility vehicle according to an embodiment of the present invention;

FIG. 2 is a top view of the utility vehicle of FIG. 1;

FIG. 3 is a perspective view showing a part of a vehicle body frame, an engine, and an exhaust device of FIGS. 1 and 2;

FIG. 4 is a side view showing the exhaust device; and

FIG. 5 is a perspective view of FIG. 4.

### DETAILED DESCRIPTION OF THE INVENTION

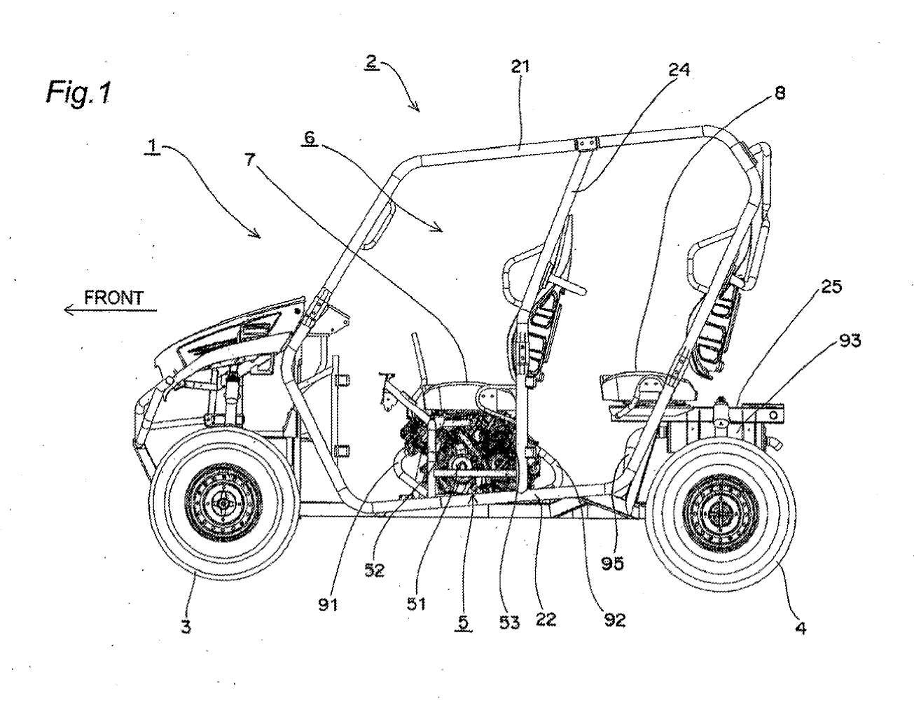

FIGS. 1 to 5 show a utility vehicle and an exhaust device according to an embodiment of the present invention. The present embodiment will be described based on the drawings. It should be noted that in the following description, a concept of the direction used in the present embodiment corresponds to a concept of the direction seen from a driver of the utility vehicle.

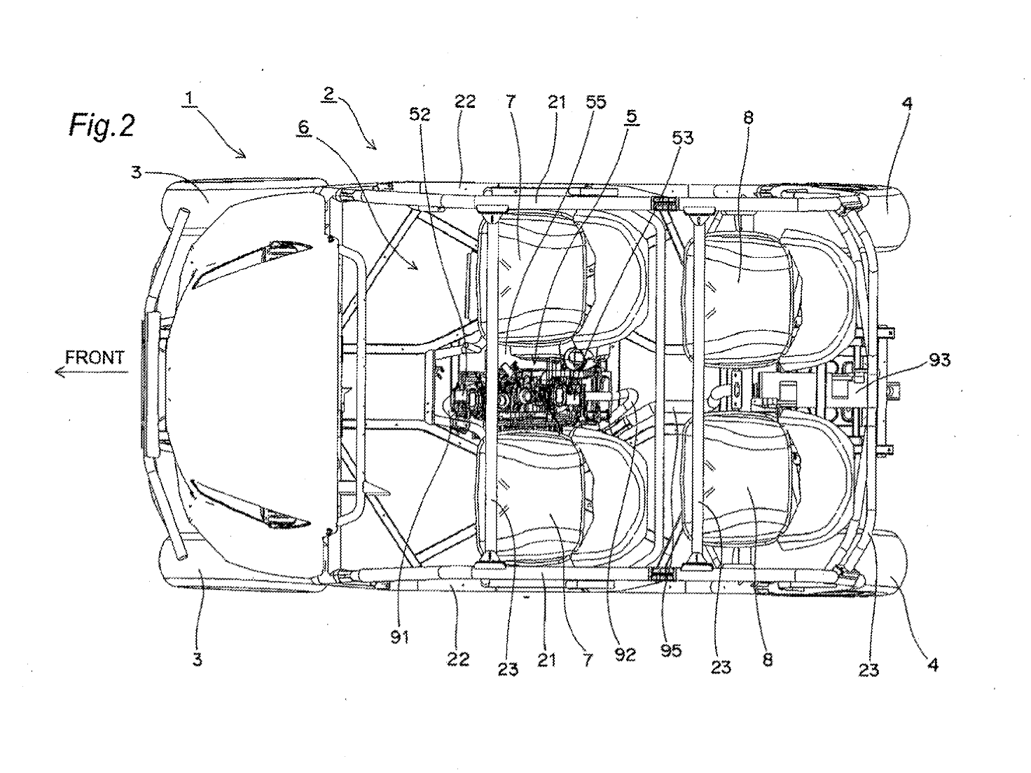

FIG. 1 is a left side view of the utility vehicle according to the embodiment of the present invention, and FIG. 2 is a top view of the utility vehicle of FIG. 1. A utility vehicle 1 is provided with a pair of left and right front wheels 3 and a pair of left and right rear wheels 4 respectively in a front part and a rear part of a vehicle body frame 2, and a V-twin engine 5 is mounted between the front and rear wheels 3, 4.

The vehicle body frame 2 has a pair of left and right cabin frames (BOPS) 21 formed by metal pipes into a reversed U shape, main frames 22 formed by metal pipes into a U shape, the main frames being coupled to the cabin frames (ROPS) 21 from the lower side, a plurality of cross members 23 formed by metal pipes, the cross members coupling the pair of left and right cabin frames (ROPS) 21, and upper pillar pipes 24 coupling intermediate parts in the front and rear direction of the cabin frames (BOPS) 21 and intermediate parts in the front and rear direction of the main frames 22. The cabin frames 21 are generally called as ROPS which is an abbreviation of rollover protective structure.

A front seat 7 having a box shape driver seat and a box shape passenger seat is installed in a front half part of the cabin 6 formed by the vehicle body frame 2, and a rear seat 8 having two box shape fellow passenger seats is installed in a rear half part of the cabin 6.

The engine 5 is provided with a front cylinder 52 with a forward tilting posture and a rear cylinder 53 with a rearward tilting posture on the upper side of a crankcase 51. An exhaust port (not shown) is formed in a front wall of the front cylinder 52, and a front cylinder exhaust pipe 91 is connected to the exhaust port. An exhaust port (not shown) is formed in a rear wall of the rear cylinder 53, and a rear cylinder exhaust pipe 92 is connected to the exhaust port. A single muffler 93 shared by the front and rear cylinders is arranged in the vicinity of the lower side of a loading platform 25 in a rear part of the rear seat 8 and in a substantially center part in the lateral direction.

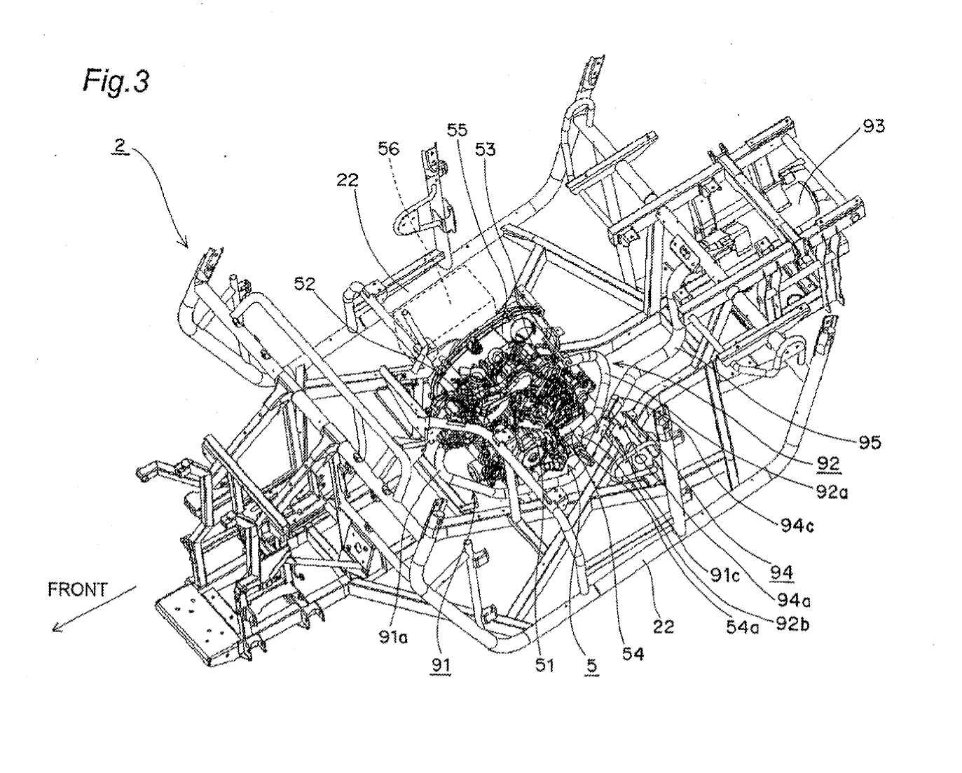

FIG. 3 is a perspective view showing a part of the vehicle body frame 2, the engine 5, and an exhaust device of FIGS. 1 and 2. The exhaust device has the front cylinder exhaust pipe 91, the rear cylinder exhaust pipe 92, the muffler 93, a collecting pipe 94 collecting the front cylinder exhaust pipe 91 and the rear cylinder exhaust pipe 92, and a downstream exhaust pipe 95 reaching from the collecting pipe 94 to the muffler 93.

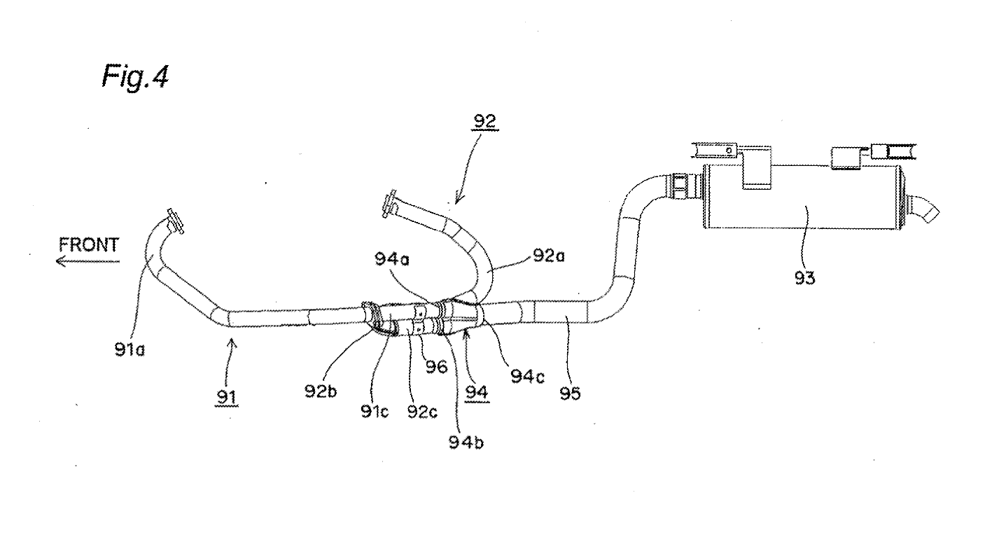

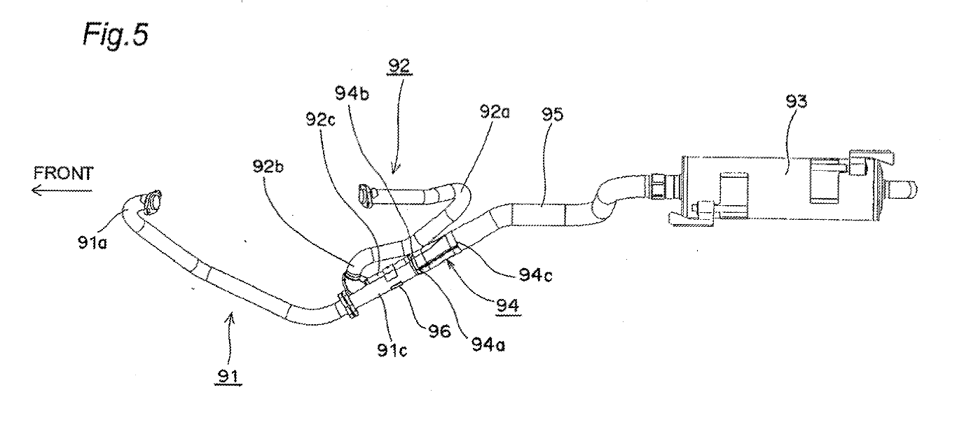

FIG. 4 is a side view showing the exhaust device, and FIG. 5 is a perspective view of FIG. 4. As shown in FIGS. 3 to 5, the front cylinder exhaust pipe 91 extends forward from the front cylinder 52 of the engine 5 and changes the direction from forward to rearward in a front exhaust pipe curved portion 91a. The front exhaust pipe curved portion 91a is positioned in the vicinity of the front side of the engine 5. The front cylinder exhaust pipe 91 extends rearward from the front exhaust pipe curved portion 91a to the left lower side, passes through the side in the lateral direction of a lower part of the engine 5, and reaches to a front exhaust pipe straight portion 91c formed into a substantially straight line. A rear end of the front exhaust pipe straight portion 91c is connected to the collecting pipe 94.

The rear cylinder exhaust pipe 92 extends rearward from the rear cylinder 53 of the engine 5, and changes the direction from rearward to forward in a first rear exhaust pipe curved portion 92a. The first rear exhaust pipe curved portion 92a is positioned in the vicinity of the rear side of the engine 5. The rear cylinder exhaust pipe 92 extends forward from the first rear exhaust pipe curved portion 92a to the left lower side, passes through the side in the lateral direction of the lower part of engine 5, and changes the direction from forward to rearward in a second rear exhaust pipe curved portion 92b. The second rear exhaust pipe curved portion 92b is positioned on the side in the lateral direction of a rear lower part of the engine 5. A cutout portion 54a is formed in a left side part in the lateral direction of an oil pan 54 positioned in the lower part of the engine 5, and a part of the second rear exhaust pipe curved portion 92b is positioned in the vicinity of the cutout portion 54a. The rear cylinder exhaust pipe 92 extends rearward from the second rear exhaust pipe curved portion 92b, passes through the side in the lateral direction of a lower rear part of the engine 5, and reaches to a rear exhaust pipe straight portion 92c formed into a substantially straight line. A rear end of the rear exhaust pipe straight portion 92c is connected to the collecting pipe 94.

The rear cylinder exhaust pipe 92 has the first rear exhaust pipe curved portion 92a and the second rear exhaust pipe curved portion 92b, so that total length thereof is extended. As a result, total length of the front cylinder exhaust pipe 91 and the total length of the rear cylinder exhaust pipe 92 are substantially the same. For example, a ratio between the total length of the front cylinder exhaust pipe 91 and the total length of the rear cylinder exhaust pipe 92 is within a range from 3:2 to 2:3. The front exhaust pipe straight portion 91c and the rear exhaust pipe straight portion 92c respectively have length of at least 100 mm, and are integrally supported by one support member 96.

The collecting pipe 94 has two inlets 94a, 94b in a front end thereof, and one outlet 94c in a rear end. The inlets 94a, 94b are respectively connected to the front exhaust pipe straight portion 91c and the rear exhaust pipe straight portion 92c, and the outlet 94c is connected to a front end of the downstream exhaust pipe 95. As a result, an exhaust gas passing through the front cylinder exhaust pipe 91 and an exhaust gas passing through the rear cylinder exhaust pipe 92 are collected in the collecting pipe 94 and fed to the downstream exhaust pipe 95.

As shown in FIG. 3, a V-belt continuously variable transmission 55 for transmitting rotation force of a main shaft of the engine 5 to the rear wheels 4 by a V-belt is provided in a right part of the engine 5, and a fuel tank 56 storing fuel to be supplied to the engine 5, the fuel tank shown by a broken line is arranged on the right side in the lateral direction of the continuously variable transmission 55. The collecting pipe 94 collecting the front cylinder exhaust pipe 91 and the rear cylinder exhaust pipe 92 is arranged on the opposite side in the lateral direction (on the left side in the lateral direction) of the continuously variable transmission 55 and the fuel tank 56 relative to the engine 5.

As shown in FIGS. 1 to 3, the downstream exhaust pipe 95 extends rearward from a connection part with the collecting pipe 94, passes through the lower side of the substantially center part in the lateral direction of the rear seat 8, goes to the upper side, and is connected to a front end of the muffler 93 attached to a lower surface of the loading platform 25 in the substantially center part in the lateral direction. A front part of the loading platform 25 supports a seating portion of the rear seat 8.

An attaching order of the exhaust device is as follows. Firstly, the collecting pipe 94 is connected to the front end of the downstream exhaust pipe 95. Next, an exhaust upstream end of the front cylinder exhaust pipe 91 is connected to the exhaust port of the front cylinder 52, and an exhaust downstream end of the front cylinder exhaust pipe 91 is connected to the collecting pipe 94. Accordingly, an exhaust upstream end of the rear cylinder exhaust pipe 92 is connected to the exhaust port of the rear cylinder 53, and an exhaust downstream end of the rear cylinder exhaust pipe 92 is connected to the collecting pipe 94. The front exhaust pipe straight portion 91c of the front cylinder exhaust pipe 91 and the rear exhaust pipe straight portion 92c of the rear cylinder exhaust pipe 92 are supported by the support member 96. Then, the muffler 93 is connected to a rear end of the downstream exhaust pipe 95 from the rear side, and attached to the lower surface of the loading platform 25.

As described above, the front cylinder exhaust pipe 91, the rear cylinder exhaust pipe 92, the collecting pipe 94, and the downstream exhaust pipe 95 are supported not by the vehicle body frame 2 or the like but by the front cylinder 52, the rear cylinder 53, the support member 96, and the muffler 93.

According to the above embodiment, the following effects can be obtained.

(1) The total length of the front cylinder exhaust pipe 91 and the total length of the rear cylinder exhaust pipe 92 are substantially the same. Thus, exhaust interference generated between the front cylinder exhaust pipe 91 and the rear cylinder exhaust pipe 92 can be suppressed, and further an exhaust performance of the front and rear cylinders 52, 53 can be substantially equalized. As a result, an output of the engine 5 can be improved.

(2) Since the front cylinder exhaust pipe 91 is provided with the front exhaust pipe curved portion 91a, and the rear cylinder exhaust pipe 92 is provided with the first rear exhaust pipe curved portion 92a and the second rear exhaust pipe curved portion 92b, the total length of the front cylinder exhaust pipe 91 and the total length of the rear cylinder exhaust pipe 92 can be easily made substantially the same. The front exhaust pipe curved portion 91a is positioned in the vicinity of the front side of the engine 5, the first rear exhaust pipe curved portion 92a is positioned in the vicinity of the rear side of the engine 5, and the second rear exhaust pipe curved portion 92b is positioned in the vicinity of the side in the lateral direction of a rear part of the engine 5. Thus, the front cylinder exhaust pipe 91 and the rear cylinder exhaust pipe 92 can be arranged around the engine 5. As a result, a thermal influence from the front cylinder exhaust pipe 91 and the rear cylinder exhaust pipe 92 to the outer side in the lateral direction can be reduced.

(3) The collecting pipe 94 is arranged on the opposite side in the lateral direction of the continuously variable transmission 55 and the fuel tank 56 relative to the engine 5. Thus, the front cylinder exhaust pipe 91, the rear cylinder exhaust pipe 92, and the collecting pipe 94 having a relatively high temperature among the exhaust pipes are spaced from the continuously variable transmission 55 and the fuel tank 56 by a fixed distance via the engine 5. Therefore, the thermal influence on the continuously variable transmission 55 and the fuel tank 56 by the front cylinder exhaust pipe 91, the rear cylinder exhaust pipe 92, and the collecting pipe 94 can be reduced.

(4) The front cylinder exhaust pipe 91 and the rear cylinder exhaust pipe 92 respectively have the front exhaust pipe straight portion 91c formed into a straight line and the rear exhaust pipe straight portion 92c formed into a straight line in the connection parts to the collecting pipe 94. Thus, movement of exhaust from the front cylinder exhaust pipe 91 to the collecting pipe 94, and movement of exhaust from the rear cylinder exhaust pipe 92 to the collecting pipe 94 can be smoothly performed.

(5) The front exhaust pipe straight portion 91c and the rear exhaust pipe straight portion 92c are integrally supported by the shared support member 96. Thus, the support member 96 can be simplified, so that the front exhaust pipe straight portion 91c and the rear exhaust pipe straight portion 92c can be supported in a rational manner. The front exhaust pipe straight portion 91c and the rear exhaust pipe straight portion 92c having fixed length in a straight line are supported by the support member 96. Thus, integrity of the front cylinder exhaust pipe 91 and the rear cylinder exhaust pipe 92 can be improved. As a result, vibration generated between the front cylinder exhaust pipe 91 and the rear cylinder exhaust pipe 92 can be eased.

(6) A part of the second rear exhaust pipe curved portion 92b is positioned in the vicinity of the cutout portion 54a of the oil pan 54. Thus, the rear cylinder exhaust pipe 92 can be brought close to the left side in the lateral direction of the engine 5, so that the thermal influence from the rear cylinder exhaust pipe 92 to the outer side in the lateral direction can be reduced.

(7) The engine 5 and the muffler 93 are arranged in the substantially center part in the lateral direction, and the downstream exhaust pipe 95 passes through the lower side of the substantially center part in the lateral direction of the rear seat 8. Thus, total length of the downstream exhaust pipe 95 can be shortened. As a result, weight of the downstream exhaust pipe 95 can be reduced, and the output of the engine at the time of high speed can be improved. Since the downstream exhaust pipe 95 is arranged in the substantially center part in the lateral direction, the thermal influence from the downstream exhaust pipe 95 to the outer side in the lateral direction can be reduced.

(8) The front cylinder exhaust pipe 91, the rear cylinder exhaust pipe 92, the collecting pipe 94, and the downstream exhaust pipe 95 are supported by the front cylinder 52, the rear cylinder 53, the support member 96, and the muffler 93. Thus, there is no need for separately providing a support member for the above members in the vehicle body frame 2 or the like, so that a support structure can be simplified. By simplifying the support structure, an extra arrangement space can be obtained around the front cylinder exhaust pipe 91, the rear cylinder exhaust pipe 92, the collecting pipe 94, and the downstream exhaust pipe 95.

In the present embodiment, the downstream exhaust pipe 95 passes through the lower side of the substantially center part in the lateral direction of the rear seat 8. However, in a case where the front cylinder exhaust pipe 91 and the rear cylinder exhaust pipe 92 are not collected by the collecting pipe 94, the exhaust pipes are preferably connected to the muffler 93 through the lower side of the substantially center part in the lateral direction of the rear seat 8 so that the total length of the exhaust pipes is shortened.

In the present embodiment, the front cylinder exhaust pipe 91 has the front exhaust pipe curved portion 91a. However, the number of a curved portion to be provided is not limited to one as in the front exhaust pipe curved portion 91a but other curved portions may be provided. The rear cylinder exhaust pipe 92 has the first rear exhaust pipe curved portion 92a and the second rear exhaust pipe curved portion 92b. However, the number of a curved portion to be provided is not limited to two as in the first rear exhaust pipe curved portion 92a and the second rear exhaust pipe curved portion 92b but other curved portions may be provided. That is, in the front cylinder exhaust pipe 91 and the rear cylinder exhaust pipe 92, a proper number of curved portions are preferably formed so that the total length of the front cylinder exhaust pipe 91 and the total length of the rear cylinder exhaust pipe 92 are made substantially the same and the front cylinder exhaust pipe 91 and the rear cylinder exhaust pipe 92 are arranged in the vicinity of the engine 5.

### OTHER EMBODIMENTS OF THE INVENTION

(1) The present invention is applicable to a twin engine other than the V-twin engine.

(2) The present invention is applicable to a vehicle for irregular terrain other than the vehicle in the above embodiment.

The present invention can provide the exhaust device capable of suppressing the exhaust interference generated between the front cylinder exhaust pipe and the rear cylinder exhaust pipe, and further substantially equalizing the exhaust performance of the front and rear cylinders. Thus, the present invention has a great applicability in industry.

1. An exhaust device of a vehicle provided with a V-engine having a front cylinder and a rear cylinder, comprising:
a muffler arranged in a rear part of the vehicle;
a front cylinder exhaust pipe connected to a front surface of the front cylinder;
a rear cylinder exhaust pipe connected to a rear surface of the rear cylinder;
a collecting pipe collecting the front cylinder exhaust pipe and the rear cylinder exhaust pipe; and
a downstream exhaust pipe reaching from the collecting pipe to the muffler, wherein
total length of the front cylinder exhaust pipe and total length of the rear cylinder exhaust pipe are substantially the same.

2. The exhaust device according to claim 1, wherein
the collecting pipe is arranged on the side in the lateral direction of a rear part of the engine,
the front cylinder exhaust pipe has a front exhaust pipe curved portion changing the direction from forward to rearward,
the front exhaust pipe curved portion is positioned in the vicinity of the front side of the engine,
the rear cylinder exhaust pipe has, in order from the exhaust upstream side, a first rear exhaust pipe curved portion changing the direction from rearward to forward, and a second rear exhaust pipe curved portion changing the direction from forward to rearward,
the first rear exhaust pipe curved portion is positioned in the vicinity of the rear side of the engine, and the second rear exhaust pipe curved portion is positioned in the vicinity of the side in the lateral direction of the rear part of the engine.

3. The exhaust device according to claim 2, wherein
the collecting pipe is arranged on the opposite side in the lateral direction of a fuel tank or a transmission of the vehicle relative to the engine.

4. The exhaust device according to claim 2, wherein
the front cylinder exhaust pipe has a front exhaust pipe straight portion formed into a straight line in a connection part to the collecting pipe, and
the rear cylinder exhaust pipe has a rear exhaust pipe straight portion formed into a straight line in a connection part to the collecting pipe.

5. The exhaust device according to claim 3, wherein
the front exhaust pipe straight portion and the rear exhaust pipe straight portion are integrally supported by a shared support member.

6. The exhaust device according to claim 2, wherein
a cutout portion of an oil pan is formed in a side part in the lateral direction of the oil pan of the engine, and
a part of the second rear exhaust pipe curved portion is positioned in the vicinity of the cutout portion.

7. The exhaust device according to claim 1, wherein
the vehicle has a front seat and a rear seat in order from the front side,
the engine is arranged on the lower side of a substantially center part in the lateral direction of the front seat,
the muffler is arranged in the vicinity of the lower side of a loading platform in a rear part of the rear seat and in a substantially center part in the lateral direction, and
the downstream exhaust pipe reaches to the muffler through the lower side of the substantially center part in the lateral direction of the rear seat.

8. An exhaust device of a vehicle provided with an engine having one or more cylinder, comprising:
a muffler; and
an exhaust pipe connected to the cylinder, the exhaust pipe reaching to the muffler, wherein
the vehicle has a front seat and a rear seat in order from the front side,
the engine is arranged on the lower side of a substantially center part in the lateral direction of the front seat,
the muffler is arranged in the vicinity of the lower side of a loading platform in a rear part of the rear seat and in a substantially center part in the lateral direction, and
the exhaust pipe reaches to the muffler through the lower side of the substantially center part in the lateral direction of the rear seat.

9. A utility vehicle provided with the exhaust device according to claim 1.

10. A utility vehicle provided with the exhaust device according to claim 8.
